(19) United States
(12) Patent Application Publication
(10) Pub. No.: US 2026/0302850 A1
(43) Pub. Date: Oct. 1, 2026

(54) Stator Body with Axial Coolant Channels

(71) Applicant: Bayerische Motoren Werke Aktiengesellschaft, Muenchen (DE)

(72) Inventors: Andreas Wagner, St. Valentin (AT); Jochen Kronsteiner, St. Ulrich bei Steyr (AT); Gerald Pichler, Gaflenz (AT)

(21) Appl. No.: 19/476,972

(22) PCT Filed: Apr. 9, 2024
(86) PCT No.: PCT/EP2024/059541

§ 371 Date: Oct. 20, 2025

(30) Foreign Application Priority Data
Apr. 25, 2023 (DE) 10 2023 110 471.3

(51) Int. Cl. H02K 1/20; H02K 1/16

(52) U.S. Cl. CPC H02K 1/20; H02K 1/16

(57) ABSTRACT

A stator body for a stator of an electric machine has a base body with a plurality of stator laminations. The base body extends in an axial direction from a first outer end face to an opposite second outer end face. The base body includes at least one first axial coolant channel which runs in the axial direction through the base body. The base body also includes at least one second axial coolant channel which runs in the axial direction through the base body. The at least one second axial coolant channel has a greater radial distance from a central longitudinal axis of the stator body than the at least one first axial coolant channel.

The present application is the U.S. national phase of PCT Application PCT/EP2024/059541 filed on Apr. 9, 2024, which claims priority of German patent application No. 10 2023 110 471.3 filed on Apr. 25, 2023, the entire contents of which are incorporated herein by reference

### TECHNICAL FIELD

The disclosure relates generally to electric machines, and more specifically to cooling of a stator of an electric machine.

### BACKGROUND

An at least partially electrically driven vehicle comprises an electric machine for driving the vehicle. The electric machine comprises a stator that encloses a rotor of the electric machine. Furthermore, the electric machine typically has a coolant circuit to cool the electric machine, in particular the electrical windings of the stator. The coolant can be guided in hollow coolant channels within the stator body of the stator. Furthermore, the coolant can be sprayed onto the winding head on an end face of the stator body using nozzles.

There is a need for a more reliable cooling of the stator of an electric machine.

### SUMMARY

The above-described need, as well as others, are addressed by at least some embodiments described herein. It is pointed out that additional features of a patent claim dependent on an independent patent claim, without the features of the independent patent claim or only in combination with a subset of the features of the independent patent claim, can form a separate invention independent of the combination of all features of the independent patent claim, which can be made the subject matter of an independent claim, a divisional application, or a subsequent application. This applies equally to technical teachings described in the description which may constitute an invention independent of the features of the independent patent claims.

According to one aspect, a stator body for a stator of an electric machine is described. The stator body comprises a base body with a plurality of flat (identically formed) stator laminations. The base body extends in the axial direction (along the central longitudinal axis of the stator body) from a first outer end face to an opposite second outer end face. The stator can have in each case a winding head on the two outer end faces (of the stator body).

The base body comprises at least one first axial coolant channel and at least one second axial coolant channel which run in each case in the axial direction through the base body. The base body can have in particular N first axial coolant channels and N second axial coolant channels, e.g. (at least or precisely) one first and second coolant channel per stator tooth of the stator body. The individual coolant channels can each be formed to guide coolant, in particular a liquid coolant (such as oil). The individual coolant channels can each be formed as a bore and/or as a recess (in the axial direction through the stator body).

The base body can comprise a first partial body and a second partial body, each having one or more first axial coolant channels and one or more second axial coolant channels, wherein the first and the second partial bodies are arranged one behind the other in the axial direction. The two partial bodies can each have a part (e.g. in each case half) of the stator laminations of the base body. The two partial bodies can be formed identically.

The base body can comprise a stator component arranged between the first partial body and the second partial body, which stator component is formed to guide coolant from outside the stator body into the one or more first and second axial coolant channels of the first and second partial bodies. The stator component itself can be formed as a stator lamination or as a set of multiple stator laminations. A hollow distribution ring can be arranged in the stator component, via which the coolant (in particular a cooling liquid, such as oil) can be directed to the individual axial coolant channels. This allows for a central supply of coolant to the stator body, enabling particularly reliable and efficient cooling.

The one or more, in particular N, second axial coolant channels have a greater radial distance from the central longitudinal axis of the stator body than the one or more, in particular N, first axial coolant channels. The one or more second axial coolant channels can be arranged relatively close (compared to the one or more first axial coolant channels) to the lateral surface of the base body or the stator body. The one or more second axial coolant channels can each be axial coolant channels close to the yoke. On the other hand, the one or more first axial coolant channels can be arranged relatively close (compared to the one or more second axial coolant channels) to the air gap to the rotor of the electric machine. The one or more first axial coolant channels can each be axial coolant channels close to the teeth.

A stator body is thus described which enables particularly reliable cooling of the stator by using a combination of first and second axial coolant channels (which are arranged at different distances from the central longitudinal axis).

The individual stator laminations (of the stator body and/or the base body) can each have N stator teeth which are arranged, in particular evenly distributed, around the central longitudinal axis of the stator body, with N>1, in particular N≥4 or N≥8 or N≥16. The individual stator laminations can furthermore each have a stator yoke on which the N stator teeth are arranged and extend from the stator yoke to the central longitudinal axis of the stator body (and to the air gap). The stator yoke can be delimited by the outer lateral surface of the stator body. In particular, the outer lateral surface of the stator body can be formed by the outer edge of the stator yoke of the plurality of stator laminations (of the stator body and/or the base body). On the inner side (toward the central longitudinal axis), the stator yoke can be delimited by the transition to the N stator teeth.

In each case one stator slot can be arranged between two directly adjacent stator teeth. The windings of the stator can be arranged in the stator slots around the individual stator teeth.

The one or more, in particular the N, first axial coolant channels can run at least partially, in particular over 40% or more, within one or more of the N stator teeth. In particular, a first axial coolant channel can be arranged in each of the N stator teeth (wherein the cross-sectional area of each of the individual first axial coolant channels can be arranged over 40% or more within the respective stator tooth). The one or more first axial coolant channels can each have a rod-shaped cross-sectional area (perpendicular to the axial direction) with a length along the radial direction that is significantly (e.g. by a factor of 4 or more) greater than the width in the circumferential direction of the stator body. 40% or more of the length of the cross-sectional area of the individual first axial coolant channels can in each case be arranged in a stator tooth.

On the other hand, the one or more, in particular the N, second axial coolant channels can run within the stator yoke, in particular completely. The individual second axial coolant channels can be arranged in each case in radial alignment with a stator slot arranged between two stator teeth. The individual second axial coolant channels can each be arranged between different, directly adjacent, pairs of the N stator teeth (each radially aligned with the respective stator slot). Thus, a second axial coolant channel can be provided in alignment with each individual stator slot. The individual second axial coolant channels can each have a circular cross-sectional area (perpendicular to the axial direction). Alternatively or additionally, the length (in the radial (in direction) and the width the circumferential direction) of the cross-sectional area of the individual second axial coolant channels can be substantially equal.

The outer lateral surface of the base body or the stator body can run with a certain outer radius around the central longitudinal axis of the stator body. The one or more second axial coolant channels can be arranged in each case at a distance of 10% or less, in particular 5% or less, of the outer radius from the outer lateral surface. On the other hand, the one or more first axial coolant channels can each be arranged at a distance of 15% or more, in particular 20% or more, of the outer radius from the outer lateral surface.

By arranging the first and second axial coolant channels in rings of different sizes (with different radii) around the central longitudinal axis of stator body, particularly reliable cooling of the stator can be achieved.

The stator body can have on at least one end face (typically on both end faces) in each case a nozzle stator lamination comprising at least one nozzle arranged such that the nozzle can be fed with coolant from the at least one first axial coolant channel of the base body (or is fed during operation of the stator). The nozzle can be formed to direct a coolant jet onto the stator winding head arranged on the respective end face of the stator body. This allows for efficient and reliable cooling of the winding head.

The nozzle stator lamination can furthermore comprise a bore for lengthening the second axial coolant channel of the base body. The nozzle stator lamination can have in each case a bore for each of the second axial coolant channels. The coolant exiting from the individual second axial coolant channels can be used on the respective end face to cool the respective winding head of the stator.

A nozzle stator lamination can have several nozzles which are arranged, in particular evenly distributed, around the longitudinal axis of the stator body. This allows for particularly reliable cooling of the stator winding heads. The nozzle stator lamination can have e.g. (exactly) N nozzles, which are fed with coolant from the corresponding N first axial coolant channels, in particular in a one-to-one relationship. Alternatively, the nozzle stator lamination can have (exactly) N/2 nozzles, each of which is fed with coolant from two of the N first axial coolant channels. Thus, exactly one nozzle can be provided for each pair of first axial coolant channels.

The stator body can have (on both end faces respectively) a supply line stator lamination which is arranged between the respective outer end face of the base body and the e nozzle stator lamination, and which has a respective connecting line between the at least one first axial coolant channel of the base body and the nozzle of the nozzle stator lamination. In this case, the connecting line can be formed as a recess within the supply line stator sheet. A supply line stator lamination can correspondingly also be arranged on the other outer end face of the base body.

A supply line stator lamination can thus be arranged directly on an outer end face of the base body, followed axially by a nozzle stator lamination. This ensures reliable guidance of coolant through the stator body.

The base body can have two first axial coolant channels which are arranged in or on two different (directly adjacent) stator teeth of the base body or the stator body. A connecting line of a supply line stator lamination can be formed to connect the two first axial coolant channels to the same nozzle of a nozzle stator lamination, so that the nozzle of the nozzle stator lamination can be supplied with coolant from both first axial coolant channels (and is supplied during operation of the stator). This allows for a particularly reliable coolant flow through the stator body and a particularly reliable formation of a coolant jet for cooling a winding head of the stator.

The individual supply line stator laminations can each comprise a bore for lengthening the second axial coolant channel of the base body.

In particular, a bore can be provided for every second axial coolant channel. Reliable guidance of coolant through the stator body can thus be brought about.

The stator body can be formed on the second outer end face of the base body in a corresponding, in particular identical, manner as on the first outer end face of the base body. Consequently, embodiments relating to the first end face of the stator body or the base body are applicable in a corresponding manner to the second end face of the stator body or the base body.

The individual stator laminations (for the base body, the one or more nozzle stator laminations, and/or the one or more supply line stator laminations) of the stator body can be structurally identical (apart from one or more recesses for the first and second axial coolant channels, for the nozzles, or for the connecting lines). In particular, the individual stator laminations can each have a stator yoke (with a uniform outer diameter) and N stator teeth. Furthermore, the individual stator laminations can each have a uniform thickness (in the axial direction), e.g. a thickness between 1 mm and 5 mm. This enables particularly cost-efficient production of the stator body.

According to a further aspect, a stator for an electric machine is described. The stator comprises a stator body which is formed as described in this document. The stator can furthermore comprise a first winding head arranged on the first end face of the stator body and/or a second winding head arranged on the second end face of the stator body. The nozzles of the stator body (in particular the nozzles of the one or more nozzle stator laminations) and/or the second axial coolant channels may each be formed to bring about coolant jets with coolant onto the respective winding head in order to bring about efficient, reliable, and targeted cooling of the respective winding head.

According to a further aspect, an electric machine, in particular a synchronous machine, with a rotor and with a stator is described, wherein the stator is formed as described in this document.

The electric machine can be formed to guide coolant from an outer lateral surface of the stator body of the stator into one or more first and second axial coolant channels of the stator body of the stator, in particular at a location arranged centrally in the axial direction between the two partial bodies of the stator body. The electric machine can furthermore be configured to collect coolant from the one or more first and second axial coolant channels, which was used to cool a winding head of the stator, on at least one end face of the stator body of the stator. This coolant can be fed back to the one or more first and second axial coolant channels.

A coolant circuit can thus be provided for efficient and reliable cooling of the stator windings and/or the winding heads of the stator.

According to a further aspect, a (road) motor vehicle (in particular a passenger car or a truck or a bus or a motorcycle) is described which comprises the electric machine described in this document.

It should be noted that the devices and systems described in this document can be used both alone and in combination with other devices and systems described in this document. Furthermore, any aspects of the devices and systems described in this document can be combined in a variety of ways. In particular, the features of the claims can be combined with one another in a variety of ways. Furthermore, features listed in parentheses are to be understood as optional features.

The above-described features and advantages, as well as others, will become more readily apparent to those of ordinary skill in the art by reference to the following detailed description and accompanying drawings.

### BRIEF DESCRIPTION OF THE DRAWINGS

FIG. 1a shows an exemplary electric machine;

FIG. 1b shows an exemplary winding head on an end face of a stator;

FIG. 2 shows an isometric view of an exemplary multi-part stator body;

FIG. 3a shows an isometric view of an exemplary multi-part stator body with groove-proximal (first) and yoke-proximal (second) coolant channels; and

FIG. 3b shows an exemplary flow of coolant through a stator body.

### DETAILED DESCRIPTION

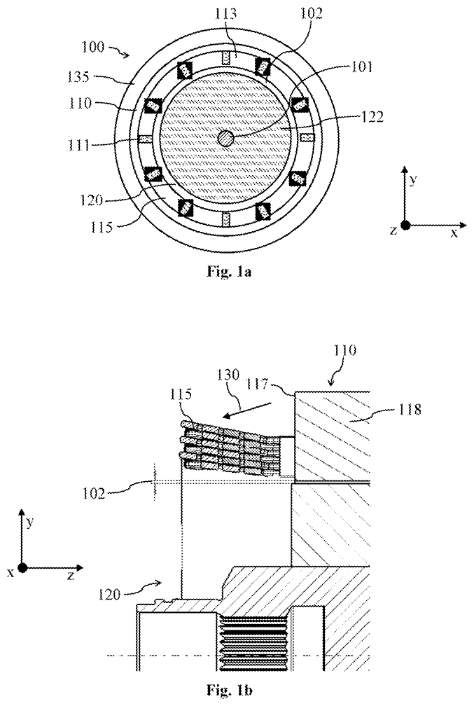

As stated at the outset, the present document deals with increasing the reliability of cooling a stator of an electric machine. In this context, FIG. 1a shows an exemplary electric machine 100 in a view perpendicular to the shaft 101 of the electric machine 100. The shaft 101 of the electric machine 100 can correspond to the longitudinal axis of the stator 110 and/or the rotational axis of the rotor 120 of the electric machine 100. The shaft 101 runs along the z-axis of the represented Cartesian coordinate system.

The electric machine 100 comprises a stator 110 with a plurality of stator windings 111 different angular positions around the rotational axis of the rotor 120 and configured to generate an electromagnetic rotating field. The stator 110 is surrounded by a housing 135 of the electric machine 100. The individual stator windings 111 can each be arranged in a stator slot between two directly adjacent stator teeth 113 of the stator 110. An air gap 102 is arranged between the stator 110 and the rotor 120.

Furthermore, the electric machine 100 comprises the rotor 120, which is driven by the rotating field generated by the stator 110. The rotor 120 is fixedly connected to the shaft 101 driven by the electric machine 100 (which is connected to the rotor axis of the rotor 120 or corresponds to the rotor axis of the rotor 120). The rotor 120 comprises a rotor body 122.

The rotor 120 of an electric machine 100 can have a laminated iron core (e.g. composed of mutually insulated laminations) as the rotor body 122. Similarly, the stator body of the stator 110 can also be composed of individual (mutually electrically insulated) stator laminations (e.g. laminated iron).

The stator 110 extends along the rotational axis of the rotor 120 or along the longitudinal axis of the stator 110 from a first end face to an opposite second end face. The stator 110 has different magnetic stator teeth 113, which are arranged at different angular positions (evenly distributed) around the rotational axis of the rotor 120. A coil (i.e. in each case one or more turns or windings 111) can be arranged around each of the individual stator teeth 113, generating a magnetic field. The individual stator teeth 113 can thus form magnetic poles of the stator 110. The turns or windings 111 each form a winding head on the end faces of the stator 110.

Between two directly adjacent stator teeth 113 of the stator 110, a stator slot is formed in which the windings 111 are arranged. A slot extends along the longitudinal axis (i.e. along the z-axis) from the first end face to the opposite second end face of the stator 110. The windings 111 arranged in a stator slot can be electrically insulated from the (electrically conductive) stator body by means of slot insulation.

FIG. 1b illustrates the winding head 115 formed by the stator windings 111 on an end face 117 of the stator 110. The winding head 115 is typically cooled with a (liquid) coolant 130 (e.g. oil). The coolant 130 can, for example, be sprayed onto the winding head 115 using one or more nozzles (not represented). In the case of the stator 110 described in this document, the coolant 130 for cooling the winding head 115 can be efficiently drawn from coolant channels of the stator body 118 of the stator 110.

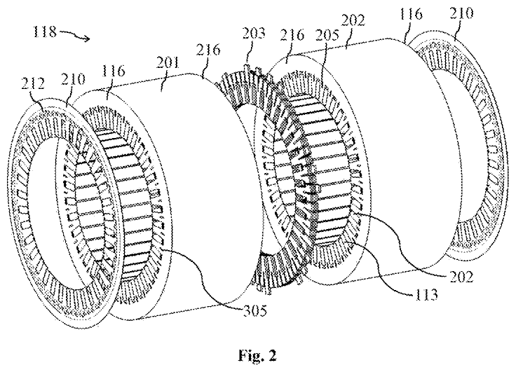

FIG. 2 shows an exemplary multi-part stator body 118 of a stator 110. The stator body 118 comprises a first partial body 201 and a second partial body 202, which are arranged one behind the other along the longitudinal axis of the stator body 118. The partial bodies 201, 202 can each be composed of a plurality of (identically formed) stator laminations, e.g. each of 50 or more, or 100 or more stator laminations. Furthermore, the two partial bodies 201, 202 can be structurally identical, so that the two partial bodies 201, 202 each form one half of the base body 201, 202 of the stator body 118.

The stator body 118 can have in each case one or more hollow coolant channels 205 in the stator yoke and/or in the individual stator teeth 113, each extending in the axial direction, i.e. in the longitudinal direction. Coolant 130 can be directed through the individual axial coolant channels 205 to cool the stator windings 111.

A central stator component 203, in particular a central stator lamination or lamination pack, can be arranged between the two partial bodies 201, 202, which rests against the central end faces 216 of the two partial bodies 201, 202. The central stator component 203 can have a stator yoke and stator teeth 113. Furthermore, the central stator component 203 can be formed to conduct coolant 130 from outside the stator body 118 into the axial coolant channels 205 of the two partial bodies 201, 202.

As set out above, the present document deals with the reliable cooling of the stator 110. The stator body 118 represented in FIG. 2 has an end face stator lamination 210 on each of the outer end faces 116 of the partial bodies 201, 202. In particular, a first end face stator lamination 210 is arranged on the outer end face 116 of the first partial body 201, and a second end face stator lamination 210 is arranged on the outer end face 116 of the second partial body 202. The individual end face (or nozzle) stator laminations 210 can each have nozzles 212 that are supplied with coolant 130 from the individual axial coolant channels 205. The nozzles 212 can be arranged evenly distributed around the central longitudinal axis of the stator 110. Through the individual nozzles 212, a coolant jet can be directed onto the winding head 115 of the stator 110.

During operation of the electric machine, heat can be generated at the windings 111 of the stator 110, i.e. in the immediate vicinity of the individual stator teeth 113. The heat generated in the windings 111 can be referred to as copper loss (since the windings 111 are typically made of copper). Furthermore, due to the magnetic field in the stator 110 which is variable over time, heat can be generated in the individual stator laminations themselves. These heat losses can be referred to as iron losses (since the stator laminations typically contain iron). The iron losses occur primarily in the area of the stator yoke.

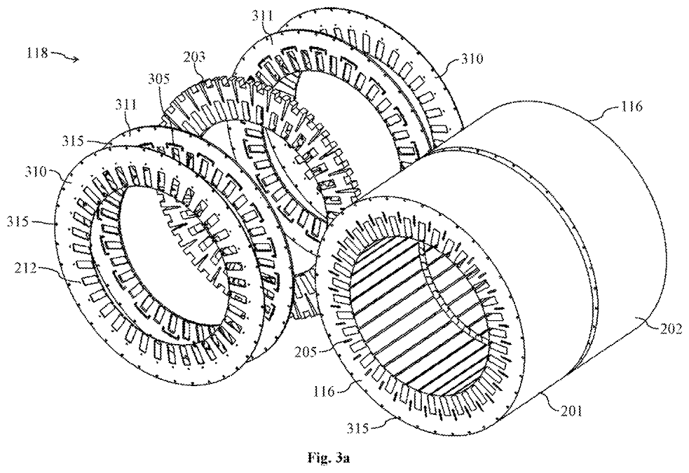

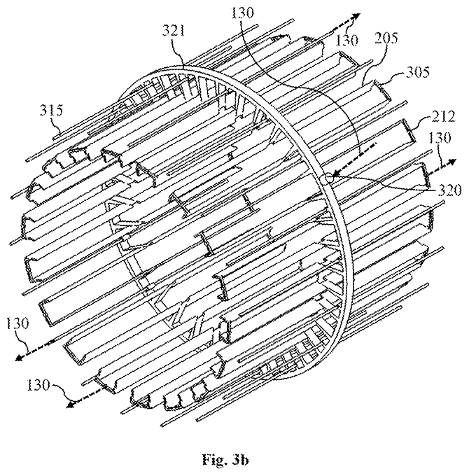

The stator body 118 represented in FIG. 3a comprises a number of first axial coolant channels 205 arranged in or on the individual stator teeth 113 and formed to dissipate heat resulting from the copper losses. Furthermore, the stator body 118 represented in FIG. 3a comprises a number of second axial coolant channels 315 arranged within the stator yoke and formed to dissipate heat resulting from the iron losses.

The first axial coolant channels 205 have a smaller radial distance from the central longitudinal axis of the stator body 118 than the second axial coolant channels 315. The individual first axial coolant channels 205 can each be arranged (optionally completely) in a stator tooth 113 or at least protrude into a stator tooth 113. The individual second axial coolant channels 315 can be arranged in the immediate vicinity of the outer lateral surface of the stator body 118. Furthermore, the individual second axial coolant channels 315 can each be arranged radially aligned with a stator slot (between two stator teeth 113). Such an arrangement of t axial coolant channels 205, 315 can achieve particularly reliable cooling of the stator 110.

The stator body 118 represented in FIG. 3a has a supply line stator lamination 311 on each of the outer end faces 116 of the two partial bodies 201, 202, wherein the supply line stator lamination 311 has connecting lines 305, each of which is formed to conduct coolant 130 from one or more, in particular from two, first axial coolant channels 205 to a respective nozzle 212 of the directly adjacent nozzle stator lamination 310. Between two stator slots, i.e. in each case in a stator tooth 113, a first axial coolant channel 205 can run in the longitudinal direction through a partial body 201, 202. A connecting line 305 can guide the coolant 130 from two directly adjacent first axial coolant channels 205 to (exactly) one nozzle 212 each, wherein the nozzle 212 is arranged in the stator yoke between two stator teeth 113.

A supply line stator lamination 311 can thus be arranged directly on the outer end face 116 of a partial body 201, 202, and a nozzle stator lamination 310 can be arranged directly on the supply line stator lamination 311. The end face 117 of the stator body 118 can be formed by the nozzle stator lamination 310.

The supply line stator lamination 311 and the nozzle stator lamination 310 can each have bores for the second axial coolant channels 315, wherein the individual bores are each axially aligned with the corresponding second axial coolant channels 315. The second axial coolant channels 315 can thus be extended to the end face 117 of the stator body 118. The coolant 130 from the second axial coolant channels 315 can be used to cool the winding head 115 at the end face 117 of the stator body 118.

FIG. 3b illustrates the flow of coolant 130 through the stator body 118. In particular, FIG. 3b shows that coolant 130 can be introduced into a distribution ring 321 of the central stator component 203 via an inlet 320. The coolant 130 is supplied to the first and second axial coolant channels 205, 315 of the first partial body 201 and the second partial body 202 via the distribution ring 321. At the outer end faces 116 of the two partial bodies 201, 202, the coolant 130 of the first axial coolant channels 205 is supplied to the individual nozzles 212 in the nozzle stator laminations 310 via the connecting lines 305 of the supply line stator laminations 311. The individual nozzles 212 each produce a jet of coolant 130 for cooling the winding heads 115. Furthermore, the individual second axial coolant channels 315 each cause a jet of coolant 130 to be directed onto the respective end face 117 of the stator body 118.

Efficient heat dissipation of the heat losses occurring in an oil-cooled stator 110 is thus described. As set out further above, the heat losses are caused by copper losses (in the windings 111) and iron losses (in the stator laminations). The stator body 118 described in this document has separate coolant channels 205, 315 for both the copper and iron losses. The coolant channels 205, which are arranged diametrically relatively far inward, primarily serve the purpose of dissipating the copper losses. The coolant channels 315, which are arranged diametrically relatively far outward (in the yoke area), are primarily focused on dissipating the iron losses.

Both sets of coolant channels 205, 315 are supplied from a common stator coolant circuit, with the distribution and/or forwarding of the coolant 130 into the various channels 305, 315 taking place via centrally arranged distribution stator laminations (of the central stator component 203). To efficiently utilize the coolant 130 at the stator ends 117 for cooling the winding heads 115, distribution and spray laminations 311, 310 are arranged at the stator ends 117. The spray or nozzle stator laminations 310, 311 serve to optimally form a hydraulic jet (spray formation) to provide the winding head cooling.

The measures described in this document ensure particularly reliable heat dissipation from the stator 110 of an electric machine 100 in order to prevent premature degradation and/or thermal overload of the electric machine 100.

The present invention is not restricted to the exemplary embodiments shown. In particular, it should be noted that the description and the figures are intended only to illustrate the principle of the proposed devices and systems by way of example.

1.-11. (canceled)

12. A stator body for a stator of an electric machine, comprising:
a base body with a plurality of stator laminations, wherein the base body extends in an axial direction from a first outer end face to an opposite second outer end face; and
wherein,
the base body includes at least one first axial coolant channel which runs in the axial direction through the base body;
the base body includes at least one second axial coolant channel which runs in the axial direction through the base body; and
the at least one second axial coolant channel has a greater radial distance from a central longitudinal axis of the stator body than the at least one first axial coolant channel.

13. The stator body as claimed in claim 12, wherein:
each of the plurality of stator laminations has N stator teeth which are arranged around the central longitudinal axis of the stator body, with N>1;
each of the plurality of stator laminations has a stator yoke on which the N stator teeth are arranged and extend from the stator yoke to the central longitudinal axis of the stator body;
the first axial coolant channel runs at least partially within one of the N stator teeth; and
the second axial coolant channel runs within the stator yoke.

14. The stator body as claimed in claim 13, wherein:
the N stator teeth which are evenly distributed around the central longitudinal axis of the stator body;
$$N \geq 4 ;$$
the first axial coolant channel runs over 40% within one of the N stator teeth; and
the second axial coolant channel runs completely within the stator yoke.

15. The stator body as claimed in claim 13, wherein the second axial coolant channel is arranged in radial alignment with a stator slot arranged between two stator teeth.

16. The stator body as claimed in claim 13, wherein the base body includes N first axial coolant channels for the N stator teeth.

17. The stator body as claimed in claim 13, wherein the base body includes N second axial coolant channels, wherein the second axial coolant channels are arranged in each case between different adjacent pairs of the N stator teeth.

18. The stator body as claimed in claim 12, wherein:
the base body includes an outer lateral surface which runs with a first outer radius around the central longitudinal axis of the stator body;
the second axial coolant channel is arranged at a distance of 10% or less of the first outer radius from the outer lateral surface; and
the first axial coolant channel is arranged at a distance of 15% or more of the first outer radius from the outer lateral surface.

19. The stator body as claimed in claim 12, wherein:
the base body includes an outer lateral surface which runs with a first outer radius around the central longitudinal axis of the stator body;
the second axial coolant channel is arranged at a distance of 5% or less of the first outer radius from the outer lateral surface; and
the first axial coolant channel is arranged at a distance of 20% or more of the first outer radius from the outer lateral surface.

20. The stator body as claimed in claim 12, further comprising:
on at least one end face a nozzle stator lamination comprising at least one nozzle arranged such that at least a first nozzle of the at least one nozzle can be fed with coolant from the at least one first axial coolant channel of the base body; and
wherein,
the nozzle stator lamination comprises a bore configured to lengthen the second axial coolant channel of the base body.

21. The stator body as claimed in claim 20, further comprising:
a supply line stator lamination arranged between an outer end face of the base body and the nozzle stator lamination, and which has a connecting line between the first axial coolant channel of the base body and the first nozzle of the nozzle stator lamination.

22. The stator body as claimed in claim 21, further comprising:
the connecting line is formed as a recess within a supply line stator sheet; and
the supply line stator lamination comprises a bore for lengthening the second axial coolant channel of the base body.

23. The stator body as claimed in claim 22, wherein:
the base body has two first axial coolant channels which are arranged in two different stator teeth of the base body; and
the connecting line of the supply line stator lamination is formed to connect the two first axial coolant channels to the first nozzle of the nozzle stator lamination, such that the first nozzle of the nozzle stator lamination can be supplied with coolant from the two first axial coolant channels.

24. The stator body as claimed in claim 12, wherein
the base body comprises a first partial body and a second partial body, each of the first partial body and the second partial body having one or more first axial coolant channels and one or more second axial coolant channels, wherein the second partial body is arranged behind the first partial body in the axial direction; and
the base body comprises a stator component arranged between the first partial body and the second partial body, the stator component configured to guide coolant from outside the stator body into the one or more first axial coolant channels and second axial coolant channels of the first and second partial bodies.

25. A stator for an electric machine, wherein the stator comprises a stator body which is formed as claimed in claim 12.

26. An electric machine, comprising a rotor and a stator, formed as claimed in claim 25, wherein the electric machine is configured to:
guide coolant from an outer lateral surface of the stator body of the stator into the at least one first axial coolant channel and the at least one second axial coolant channel; and
collect, on at least one end face of the stator body of the stator, coolant from the at least one first axial coolant channel and the at least one second axial coolant channel used to cool a winding head of the stator.

27. An electric machine as claimed in claim 26, wherein the electric machine is further configured to:
guide the coolant from the outer lateral surface of the stator body of the stator into the at least one first axial coolant channel and the at least one second axial coolant channel at a location arranged centrally in the axial direction between two partial bodies of the stator body.
